(19) United States
(12) Patent Application Publication
(10) Pub. No.: US 2011/0070791 A1
(43) Pub. Date: Mar. 24, 2011

(54) Wonder Fabric

(75) Inventor: Sachin Hanmant Kulkarni, Mumbai (IN)

(73) Assignee: Welspun Global Brands Limited, Mumbai (IN)

(21) Appl. No.: 12/569,784

(22) Filed: Sep. 29, 2009

(30) Foreign Application Priority Data
Sep. 24, 2009 (IN) 2226/MUM/2009

(51) Int. Cl. B32B 5/26; D03D 9/00

(52) U.S. Cl. 442/35; 442/1

(57) ABSTRACT

A novel textile material particularly a wonder fabric comprising of a see-through construction of plurality of yarns intersecting one another at certain angles hydro-laminated thereof with pseudo yarns formed out of staple fibers and mechanical cross linking of yarns on at least one side under specific conditions thereof resulting into a durable and multi functional material suitable for home and apparel textile applications is disclosed herein. A process for production and apparatus thereof are also disclosed.

### FIELD OF INVENTION

This invention generally relates to a novel textile material, more particularly wonder fabric, comprising of a see-through construction of plurality of yarns intersecting one another at certain angles, hydro-laminated thereof with pseudo yarns formed out of staple fibers and mechanical cross linking of yarns on at least one side under specific conditions thereof, resulting into a durable and multifunctional material suitable for home, upholstery and apparel textile applications. The process for production and apparatus thereof are also described.

### BACKGROUND OF THE INVENTION

Traditionally, home and apparel textile fabric is produced through weaving or knitting technology. Weaving is the process of interlacement of plurality of yarns in vertical that is warp way direction with plurality of yarns in horizontal that is weft way direction. Knitting process requires only one yarn component. Using this yarn component, loops are formed followed by intermeshing of the same with the previously formed ones.

Each technology has its own application. Woven fabrics are strong and have advantage of drape and fall, are most commonly used for formal wear and most of home textile products. Knitted fabrics with their advantage of high extensibility/flexibility, softness and hugging tendency, are used for casual wear, undergarments and sometimes for sheeting applications in home textiles. Knitted fabrics lack in their strength and durability.

Both the traditional textile manufacturing processes are highly expensive and labor intensive. With day by day increasing competition, there is a high demand for cost reductions. On the other hand raw material cost is continuously increasing and labor cost is also increasing. This can be seen from the fact that Europe and America are almost out of traditional textile manufacturing business. Mostly, third world is having high concentration of this industry where low labor cost was the attraction. Year by year here also labor cost is steadily increasing and the solution of shifting of the traditional textile manufacturing base is not remaining cost advantageous.

Of all costs, raw material cost is the biggest contributor and it always contributes to the extent of 55% to 65%. Another important cost is operation cost which contributes to the extent of 10% to 15% of total cost.

From the human comfort point of view, in home and apparel textile, consumption of natural fiber, for example, cotton based products is high and is continuously increasing.

With fibers like cotton, impact of raw material cost on total cost is very high.

There is an intense relationship between yarn properties, fabric construction and fabric properties. Yarns should have certain minimum strength so as to withstand the stresses and strains of different types during weaving preparation and weaving and knitting.

On the similar lines, there exists an intense relationship between fiber properties and yarn properties. One needs to maintain certain minimum fiber properties to meet the required yarn properties. Most important of all the fiber properties is fiber length and strength. Longer and stronger fiber delivers stronger yarn. However, cost is directly dependent upon fiber length. This is how it puts a restriction on cost.

Also, it is very difficult to get all the fabric properties to the best level. Always it's a compromised approach followed for optimization of fabric properties. For example, wrinkle free 100% cotton fabric is on high demand. For this purpose cotton fabric is treated with wrinkle free finish. This brings down the tensile strength, tear strength, look and feel of the fabric will not be the same, fabric drape is also different. The wrinkle behavior improves with increased add-on of chemicals and with this increased chemical add-on, remaining fabric properties go bad. In this case, if one desires to have remaining properties also best, then there is a need for long and strong fiber meaning high cost.

With increasing demands for fabric functions like wrinkle free, odor free, antimicrobial, etc.; lot of chemical finishes are reacted with fibers in the fabric or are fixed with fibers using binders. Since they hamper fabric properties like strength, feel, etc., one needs to use expensive long and strong fibers. This adds further to the cost.

Various attempts for increasing throughput rates are made in fabric weaving and knitting. Dornier and also Pseudakoma, etc. are supplying weaving looms which can run at the speeds of 1000 to 1200 pick/minute. Mayer and Cie, Fukuwara are supplying circular knitting machines which can run at 80 to 100 r.p.m. Weaving looms with wider widths of 3.5 meter are also available which offer higher outputs.

On the similar lines, different high speed spinning technologies like Rotor spinning, air jet spinning and air vortex spinning are invented. However, ring spinning is still maintaining its dominance in yarn production. This is based upon its unique yarn structure most suitable for apparel and home textiles and also none of other spinning technologies are able to offer this yarn structure. However, ring spinning is the slowest among various yarn manufacturing technologies. Various attempts to improve its throughput rate are made and are still going on. With so many such efforts in entire traditional textile chain, one can expect some relief on operation cost.

With high speed textile machines and an increasing demand for high density fabrics, raw material quality demands are going high and there by the costs also are going high and advantage of lower operation cost is defeated.

Contrary to all this, consumer is looking for good products at lower costs.

Though ring spun yarn structure is the best, still there exists a limitation on fiber selection. One can not spin Ne 60/1 yarn from 20 mm fiber length. Similarly, Ne 60/1 yarn with strength of 16 Rkm can not run efficiently on high speed/wider Air Jet loom. This way technology has put a restriction on possibility of raw material value engineering.

Looking to today's scenario above, traditional textile technology has reached to its limit. Though one wishes for value engineering and meet market needs, it is very difficult. So there is a need to look at the subject from different angle. There is a requirement to redefine the fiber/yarn/fabric properties relationships so as to arrive at techno-economical solution.

In this direction attempts are made to work upon nonwovens. Nonwoven technology is another technology and method of producing fabrics. Using this technology, staple fibers and/or continuous filaments are bonded together to form a fabric. U.S. Pat. No. 6,736,916, U.S. Pat. No. 7,455,800, U.S. Pat. No. 7,452,834, U.S. Pat. No. 7,432,219, U.S. Pat. No. 4,805,275, U.S. Pat. No. 7,331,091, U.S. Pat. No. 6,103,061, and U.S. Pat. No. 6,063,717 disclose various ways of producing nonwovens. Nonwoven manufacturing involves web preparation, bonding, drying/curing, cutting slitting/winding.

There are various ways of bonding:

1. Mechanical bonding like malimo, needle punch and hydro entanglement;

2. Chemical bonding;

3. Thermal bonding; and

4. Combination of above

However, nonwovens are not perfect like woven or knitted fabrics and so far are not suitable for direct use in home and apparel textiles. They do exist in combination with woven or knitted fabrics. The best example is interlinings inside the garment.

Nonwovens lack in important aspects like look, drape and fall, abrasion and pilling resistance required for home and apparel textile. All these properties are not possible to be attained at the same time. For example, if bonding amount is improved so as to improve pilling resistance will hamper the hand feel and drape. The fabric becomes stiff. Another example can be that of fiber free movement if preserved, will generate good drape and feel. However, this will hamper the strength and pilling resistance. Various attempts have been made to improve nonwovens and make them suitable for apparel and home textiles. Still lot of work is going on in this direction.

European Patent No. 0896645 discloses lamination of two nonwoven fabrics using chemical adhesives. This invention relates to making nonwoven fabrics which are durable for machine washing and durable for other wet and hard use or abusive applications. The inventive fabrics retain the qualities of a spun laced nonwoven fabric which include low cost, comfort, drape ability, softness, absorbency, breathability and others while having the durability comparable to traditional knitted or woven fabrics. However, commercial success of this is limited. This fabric lacks in textile fabric look and feel/touch. Also, this fabric being originally a nonwoven lacks in pilling resistance. This fabric lacks in quick recovery from elastic deformations. If used in bottom weights, this limitation of the fabric results in cup formation at knees. This problem can be resolved through chemical adhesives, but then results in to making fabric very stiff and uncomfortable to wear. This fabric can go as the work wear that is worn on top of textile apparel fabric. At least today, we do not see this product on racks anywhere in the world meant for direct apparel and home textile application.

Another U.S. Pat. No. 3,498,874 reveals the attempt made to create a nonwoven material having a textile like look. Apertured nonwoven fabric which closely resembles woven fabric is characterized by fibers locked into place by tanglelacing that extends in a zigzag pattern along parallel bands interconnected laterally by fiber bundles defining rows of apertures between the bands. Preparation of the fabric from a loose layer of fibers, such as a random web, is illustrated by processing fiber layers on screen woven of heavier wires in one direction and 3 to 5 times as many finer wires per inch in the other screen direction. The fiber layer is traversed with fine, essentially columnar liquid streams from a manifold supplied with high pressure liquid to entangle the fibers. This product lacks in strength and durability required for its use into textile applications like home and apparel textile. Application of all such products is mostly limited to disposable products.

In U.S. Pat. No. 6,315,864, improved cloth-like base web is disclosed. In particular, the base web of the present invention has a cloth-like look and feel and improved absorbency. The base web is made by first hydroneedling a web containing pulp and/or staple fibers. A bonding material is then applied to at least one side of the web and the web is creped on at least one side. By combining a hydroneedling operation with a creping operation, a base web is produced that is strong, stretchable, very soft and absorbent. This also is a disposable product, suitable for hygiene applications.

Hydro-entanglement technology is the one which many researchers have tried to develop products which have a close resemblance to textiles. After understanding the potential of this technology, many attempts were made to use this technology to enhance traditional textile fabrics.

U.S. Pat. RE40362, U.S. Pat. No. 5,136,761, U.S. Pat. No. 4,967,456, WO/2005/059215, WO/1992/007984 disclose the attempts made for using high pressure water jets and treat face and back side of woven or knitted fabric thereby enhancing their dimensional stability, pilling resistance and mechanical properties like tensile strength. However, this is a kind of finishing process. This improves textile fabrics but at a high cost when compared to traditional textile finishing process. Therefore, we do not see its commercial advantage and application.

Reference can be made to U.S. Pat. No. 4,695,500 which discloses the use of hydro entanglement technology for stabilization of bandage woven fabric. The stabilized fabric is formed by covering one or both sides of the loosely constructed base fabric with a light web of the staple length fibers, and subjecting the composite material to hydraulic entanglement while supported on a porous forming belt configured to direct and concentrate the staple length fibers at the intersections of the yarns comprising the base fabric.

This improves the ease of bandage fabric usage. Bandage fabric feels soft and is more absorbent. However, this is a disposable product and also adds to the cost of basic product. Application is limited to bandage cloth which is used once and never washed and used again.

U.S. Pat. No. 4,145,468 discloses use of hydro-entanglement technology for manufacturing of synthetic leather substratum material. Composite fabric useful as a substratum sheet for artificial leather is composed of a woven or knitted fabric constituent and at least one non-woven fabric constituent. The nonwoven fabric comprises numerous fibrous bundles composed of a plurality of individual fibers arranged parallel to each other, and varying in the number of the individual fibers from which the bundles are formed, and numerous individual fibers independent from each other and from the fibrous bundles. The individual fibers and the fibrous bundles being randomly distributed and entangled with each other to form a body of nonwoven fabric, and the nonwoven fabric constituent and woven or knitted fabric constituent being superimposed and bonded together, to form a body of composite fabric, in such a manner that portions of the individual fibers and the fibrous bundles of the non-woven fabric constituent penetrate into the inside of the woven or knitted fabric and are entangled with a portion of fibers in the woven or knitted fabric constituent. This composite in its original format is not a durable product. Once coated with the suitable chemicals for making it synthetic leather, it becomes durable. This product is not suitable for apparel or home textile application.

Reference can be made to patent WO 2008/107907 A2. This invention relates to a composite fabric and a method and apparatus for manufacturing a composite fabric. In an embodiment composite comprises a base fabric made by weaving or knitting. A plurality of gaps is disposed in between the fibers of the yarns of the base fabric. A plurality of functional fibers is entangled in the gaps followed by swelling of the fibers, with predetermined retention to the yarns of the base fabric. This is a first attempt made to develop a fabric suitable for textile application. However, this composite has a limitation of wash durability. Also, there are limitations in entanglement of individual fibers with the fibers from yarns of base fabric. This poses a risk of entanglement of fibers from web amongst themselves and thereby resulting into problem of missed out entanglement between fibers from web and fibers from yarn of base fabric thereby resulting in to delamination and poor durability and life. Also, it does not reveal great commercial advantage over the present textile fabrics.

The German company Freudenberg and the US company BBA Nonwovens did try to develop and introduce a 100% nonwoven fabric called Evolon using spun jet technology and splittable bi-component synthetic filaments for apparel textile application. Compared to other nonwovens, Evolon was a much more durable product, processable on traditional textile dyeing and finishing machines. It also has a good drape.

However, this product was 100% synthetic and had a sueded leather touch which is not appreciated always. Also it lacked the traditional textile fabric look which people are familiar with. Also, it was expensive and did not get a commercial success.

As seen from prior arts and above, sufficient successful attempts are not made so far as to create an alternate to durable traditional textiles used for home, upholstery and apparel application. There is a need to relook at traditional textiles the way they are done today from the perspective of achieving required product attributes with ease of process and at lower costs.

The wonder fabric invention offers a solution required for today's traditional textiles. Through this invention, it is possible to deliver the right product suitable for home and apparel textile applications at costs lower than today's.

Unlike nonwovens or composites referred in prior art, wonder fabric so done is launderable and durable and processable just like traditional textiles.

This invention simplifies the traditional textile process and helps curtail cost. Woven or knitted fabric is manufactured with lightest possible construction to the extent that it is having a see through effect and is completely unstable. Required properties/attributes/functions are inculcated in the later stage during hydro-lamination with pseudo yarns and cross linking fibers in a cost effective manner.

This makes traditional textile process simple and cost effective. This also makes the final product cost effective. Wonder fabric can be dyed and finished using the same equipments and process as they are used for traditional textiles.

In one final step, this invention inculcates important attributes like high comfort, easy care or wrinkle free property, good recovery from creasing, clean and sharp look, smooth and tough surface and of course good wash durability required for apparel and home textile applications.

### OBJECT OF INVENTION

The main object of this invention is to provide a multifunctional wonder fabric comprising of fabric element with see through and unstable construction which is hydro-laminated with pseudo yarns and cross linking fibers.

Another object of invention is to provide a cost effective method and process of manufacturing fabric suitable for home, upholstery and apparel textile application.

Yet another object of the invention is to develop a new method of creating pseudo yarns in the plurality of gaps among the yarns and entangling them strongly with the yarns from woven or knitted fabric, thereby creating a look very close to traditional textile fabrics used for home, upholstery and apparel textile.

Further, object of this invention is to redefine traditional relationship between count and fabric construction with fabric properties.

Yet another object of the invention is to provide a new method and process of inculcating the required functions or attributes in the openly constructed and unstable fabric.

It is also the object of the invention is to provide a launderable fabric with high durability.

### SUMMARY OF INVENTION

In accordance with above objectives, the present invention provides a novel multifunctional wonder fabric suitable for sheeting, mattress/pillow shell and similar applications in home textiles. This fabric is also suitable for tops and bottoms, undergarments and similar applications in apparel textiles. This fabric is also suitable for curtains, furniture covers and similar products in upholstery.

According to present invention, the wonder fabric comprises an open fabric with see through and unstable construction of intersecting plurality of yarns together with pseudo yarns hydro-laminated thereby delivering a stable product with acceptable look and functions/attributes required for home, apparel and upholstery applications.

According to present invention, a fabric with see through and unstable construction is hydro-laminated with pseudo yarns on at least one side thereby inculcating properties like dimensional stability, strength and durability.

According to present invention, fibers which do not participate in the formation of pseudo yarns are cross linked with yarns of fabric thereby helps to inculcate properties like easy care/wrinkle free, recovery from creases and dimensional stability.

According to present invention, amount of entanglement depicts the textile feel, touch and behavior.

According to present invention, fabric is either woven or knitted and can be taken directly from loom or prior to dyeing or dyed or in finished form. The so hydro-laminated wonder fabric can be dyed and finished in the later stage in the same way like any other textile fabric.

### BRIEF DESCRIPTION OF DRAWINGS

The accompanying drawings, which are incorporated in and constitute a part of this specification, illustrate an implementation of the present invention, and together with the description, serve to explain the advantages and principles of the invention. The patent or application file contains at least one drawing executed in color. Copies of this patent or patent application publication with color drawings will be provided by the Office upon request and payment of the necessary fee. In the drawings:

FIG. 1 shows the schemata of cross-section of see through component fabric and of wonder fabric.

FIG. 2 shows the schemata of plan view of see through component fabric and wonder fabric.

FIG. 3 shows the equipment configuration in its entirety.

FIG. 4, 10, 11 shows the scanning electron microscope (SEM) photograph of cross-section of wonder fabric.

FIG. 5 shows the SEM photograph of plan view of wonder fabric.

FIG. 6 shows the SEM photograph of cross linking fibers and cross links.

FIG. 7 shows the process route used for manufacture of wonder fabric.

FIG. 8 and FIG. 9 show the face and back side of coated/laminated blackout curtain made out of wonder fabric.

FIGS. 12a, 12b, 13a, 13b, 14a and 14b show two textile substrate photographs when compared with photographs of the wonder fabric face side and back side: Green (FIGS. 12(a) and 9(b)), Orange (FIGS. 13(a) and (b)) in color and white bleached (FIGS. 14(a) and (b)), one can clearly find out the look aspects inculcated by the invention. From these figures, one can make out how the fabric with see through construction is converted into non transparent wonder fabric suitable for home, upholstery and apparel textile.

FIGS. 15(a) and (b) shows textile substrate.

### DETAILED DESCRIPTION OF DRAWINGS

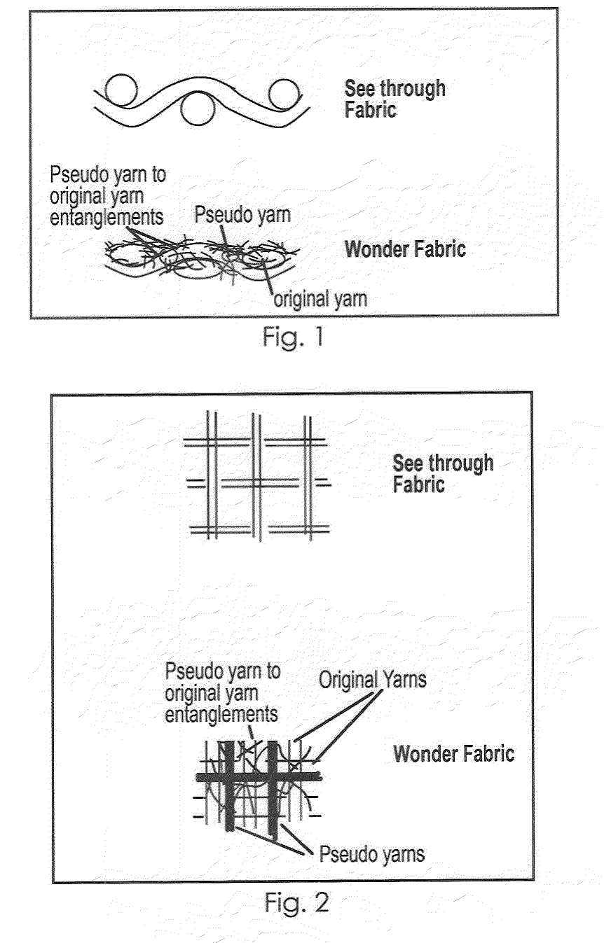

From FIGS. 1 and 2 one can see the pseudo yarns formed in the space between two consecutive yarns of the see through fabric component. One also can understand that fibers from these pseudo yarns and also external fibers entangle and create bonding between pseudo yarns and yarns of the see through fabric component.

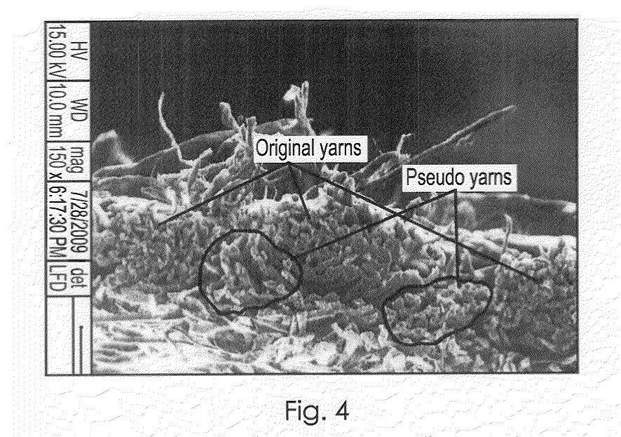

In the SEM photograph as shown in FIG. 4, 10, 11 one can see the pseudo yarns formed in the space between two successive original yarns. For better clarity, these pseudo yarns are encircled and shown. In the SEM photograph as shown in FIG. 5, one can see the pseudo yarns. External fibers bonding these pseudo yarns are also seen.

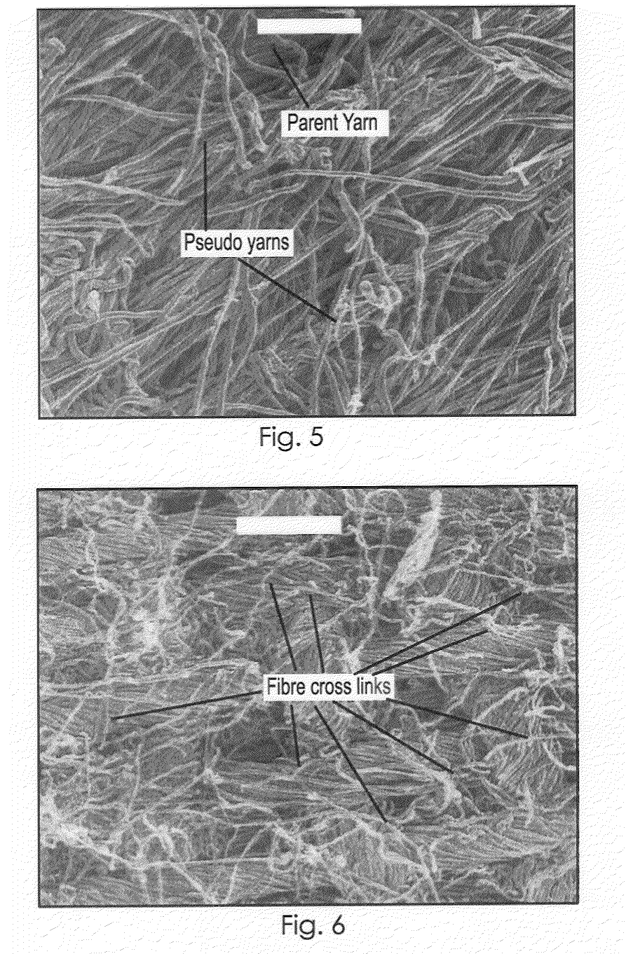

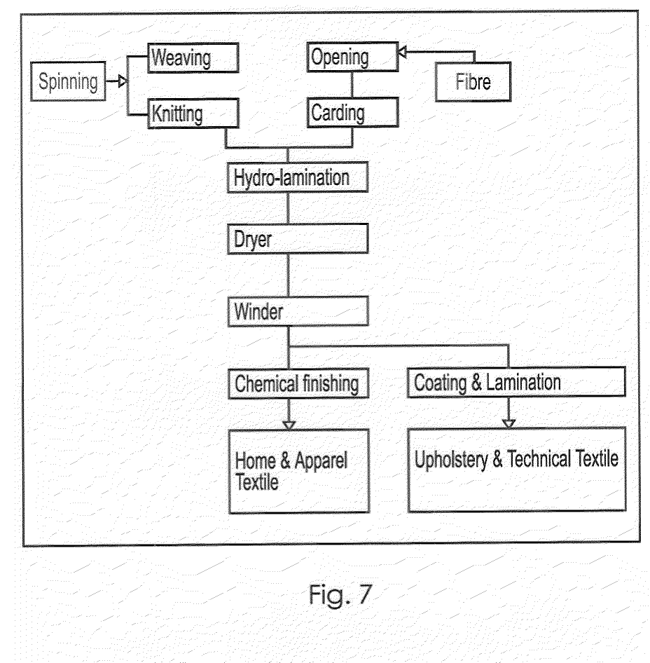

In the SEM photograph as shown in FIG. 6, there are external fibers which bond the original yarns to each other. This helps guide and control original yarn movement in the fabric. Fabric properties are depicted accordingly.

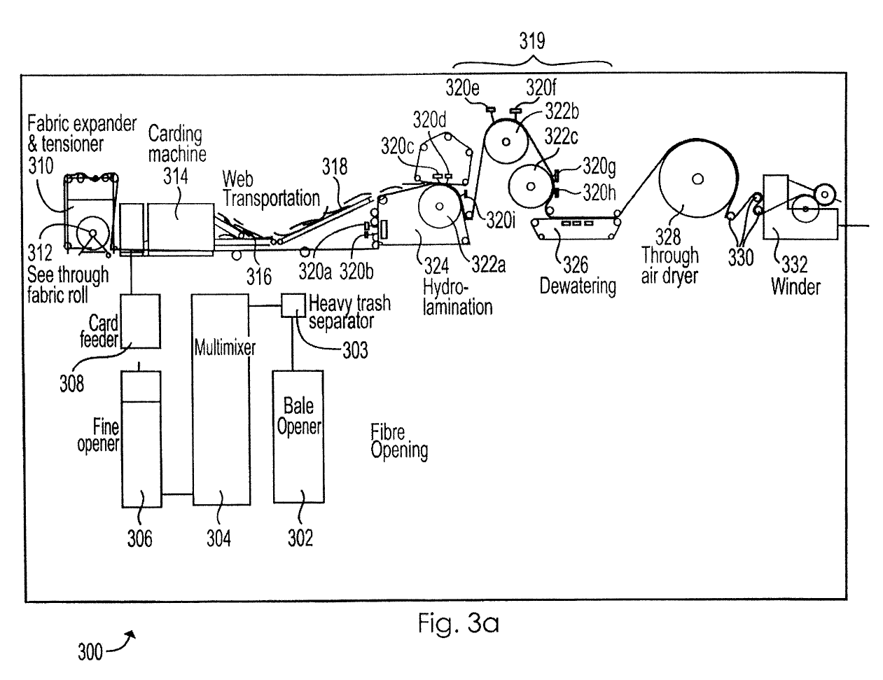

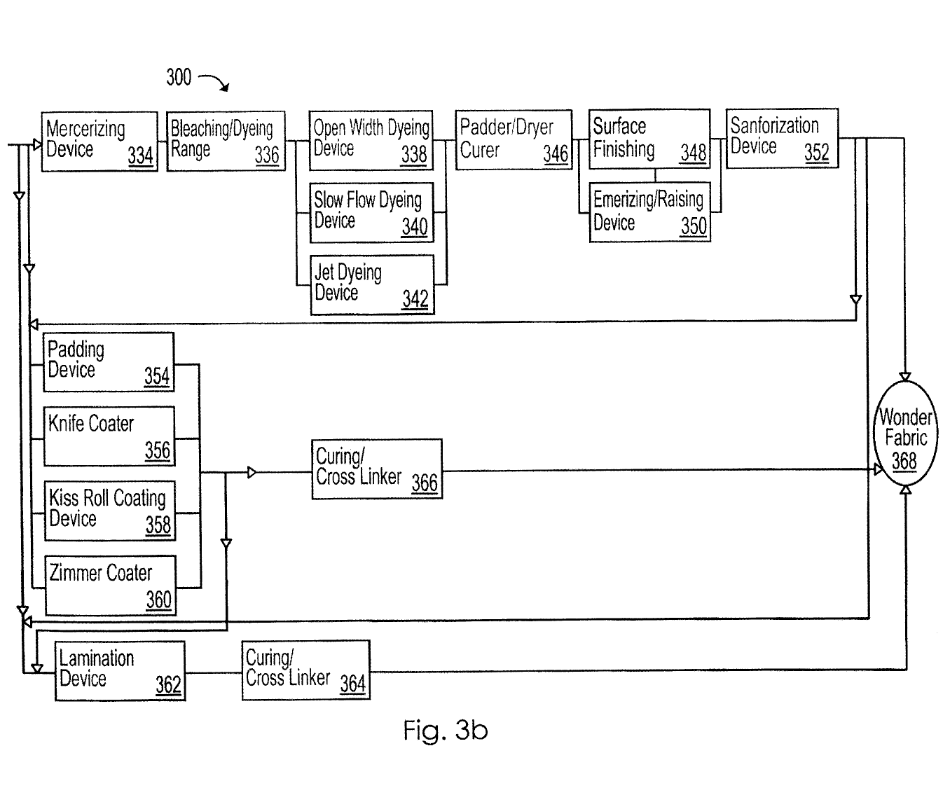

FIG. 3 shows the equipment configuration 300 used for the manufacture of this wonder fabric. This line has at least one fiber opening line with various opening, mixing/blending machines 302, 304, 306 and if cotton then cleaning machines. Thus opened and/or cleaned fiber material is fed to carding machine 314 through the card feeder 308. Here fibers are individualized and arranged in a particular manner as depicted by speeds and settings of rotating parts. For example, with proper planning and control of speeds and settings of doffer—transfer roll—random roll (not shown) and adjustment of condenser suction rate one can control fiber orientation in the machine direction, cross direction or can create a random orientation. Fibers so individualized are delivered on to fiber transport belt 318 in the form of a fiber web which is than transported to hydro-lamination device 324.

The fabric with see through construction is delivered from a fabric roll 312 arranged behind the carding machine 314. Fabric is passed through the expander 310 for proper opening followed by proper tensioning through drafting rolls in the expander 310. So opened up fabric is supported/transported by guide rolls (not shown) to hydro-lamination device 324.

In the hydro-lamination device 324, the see through fabric is hit by at least one streams of high pressure water streams delivered through injectors 320a, 320b, 320c, 320d, 320e, 320f, 320g, 320h, 320i. There may be a different number of injectors than shown. In addition, these injectors 320a, 320b, 320c, 320d, 320e, 320f, 320g, 320h, 320i are found in the hydro-lamination device 324, and at other points in the equipment configuration. At least one of the water stream strikes the fabric at an angle. Depending upon requirement, at least one water stream strikes the fabric in a direction in which fabric is moving or an opposite.

Selection of hydro-lamination parameters is guided by the final fabric properties required.

So treated fabric with relaxed and voluminized yarns is met with fiber web as shown in the FIG. 3a. Both now onwards are made to face successive steps of hydro-lamination.

Hydro-lamination is done using at least belt or perforated drums 322a, 322b, 322c with suitable shells. These drums 322a, 322b, 322c can also be found elsewhere in the equipment configuration 300. Shells depict the effective perforation area used and water rebounce.

During hydro-lamination, at least one water stream will strike the fibers and fabric at preset angle and direction from injectors 320a, 320b, 320c, 320d, 320e, 320f, 320g, 320h, 320i above. Fabric and fibers are also made to face at least one oscillating water stream. Also, fabric and fibers are made to face at least one high pressure water stream. These water streams are arranged and parameters are designed based upon properties required in the final product. Water streams are delivered by injectors 320a, 320b, 320c, 320d, 320e, 320f, 320g, 320h, 320i as shown in the FIG. 3a.

Remaining hydro-lamination parameters like jet size, jets/inch, jet length, vacuum, shell type, etc., are planned depending upon the properties required in the final product that is wonder fabric.

So formed wonder fabric is then passed on to dewatering device 326. This device removes physically held water by using vacuum.

Thus, dewatered wonder fabric is then passed through the dryer 328 for removing chemically held water. Wonder fabric so dried is finally wound on bobbins, at the winder 332. If necessary, before winding, it is slit in width wise direction to the pieces of required widths.

### DETAILED DESCRIPTION OF INVENTION

The invention will now be described in detail, along with certain preferred and optional embodiments so that various aspects thereof may be more fully understood and appreciated.

The present invention provides a unique, multifunctional and durable textile material with a look acceptable for home textile, upholstery and apparel textile application having multiple advantages over prior art.

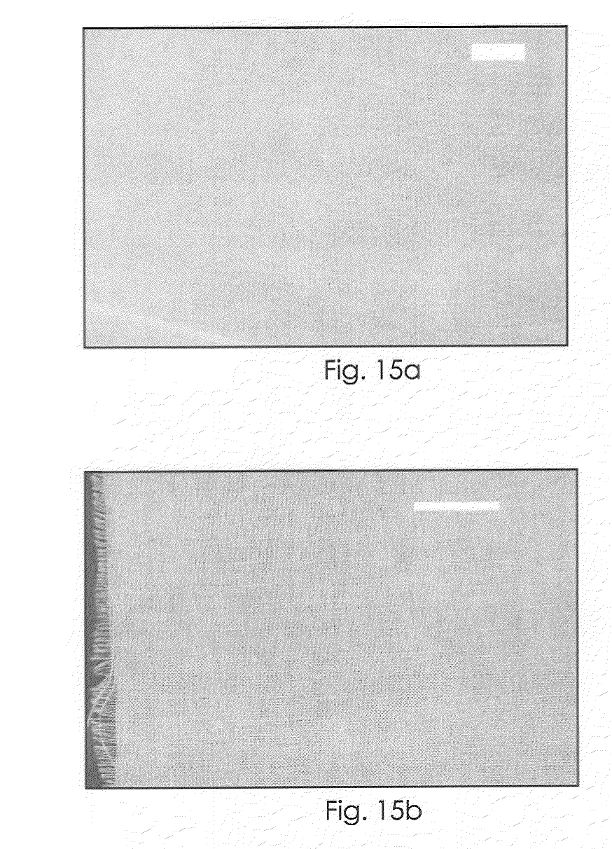

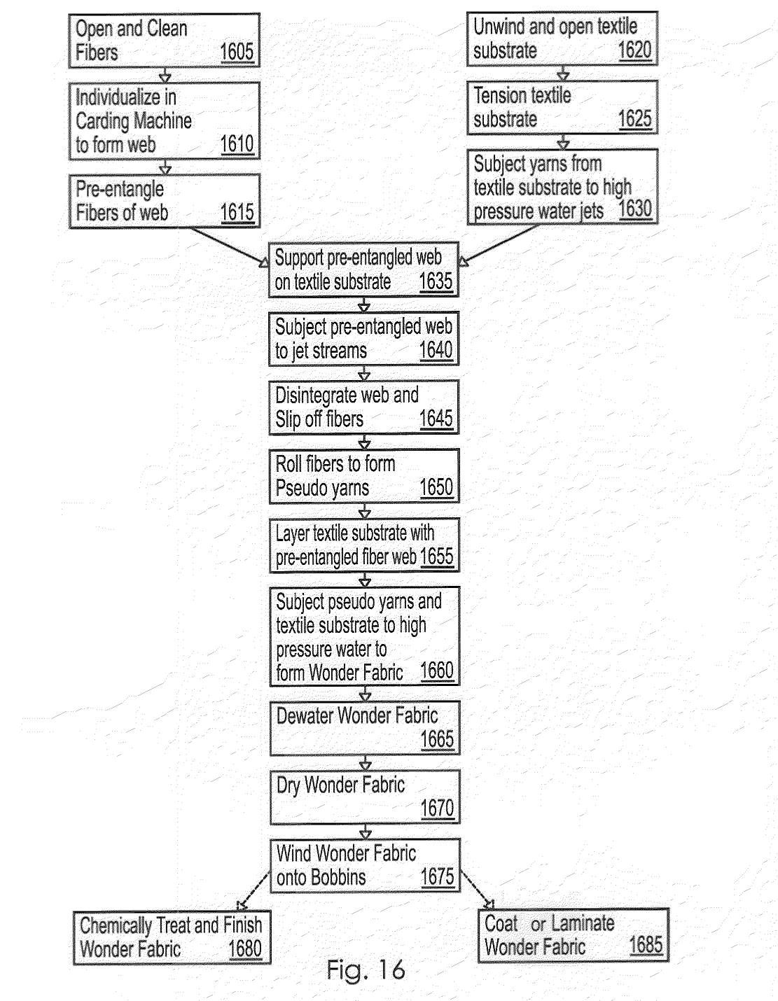

Here onwards, textile fabric with see through and unstable construction will be called as textile substrate as shown in FIGS. 15(a) and (b). As shown in FIGS. 4 and 5, at least on one side of textile substrate, pseudo yarns are formed. These pseudo yarns are entangled with textile substrate.

Textile substrate can be manufactured using weaving technology or knitting technology. Yarns those are used for manufacturing of textile substrate can be combed and/or carded yarns. Further, these yarns can be either ring spun or open end spun yarns or air jet yarns or air vortex yarns or friction spun yarns. Also, yarns spun from any other technology other than the one mentioned before can be used for manufacturing textile substrate. Also, these yarns can be monofilament yarns or multifilament yarns spun from synthetic polymer melts.

Yarns used for the manufacturing of textile substrate can be a single yarn or plied yarn. Also, these yarns can be with hard core or soft core.

Yarns used for manufacturing of textile substrate can be spun out of grey cotton or bleached cotton or dyed cotton or undyed manmade fiber or dyed manmade fiber or blends.

As shown in FIG. 6, the yarns from textile substrate are also entangled with the fibers. These fibers here onwards will be called as cross linking fibers.

Process of layering of fiber web on top side of textile substrate followed by entanglement of fibers amongst themselves thereby forming pseudo yarns followed by entanglement of pseudo yarns with yarns of textile substrate followed by entanglement of cross linking fibers with fibers of yarns from textile substrate and pseudo yarns will be called as hydro-lamination.

Hydro-entanglement device usually consists of at least one pressurized water stream delivered by injector through jet strip on to material being supported by belt or drum with or without shell. It is common that water jets from injector point towards the drum centre.

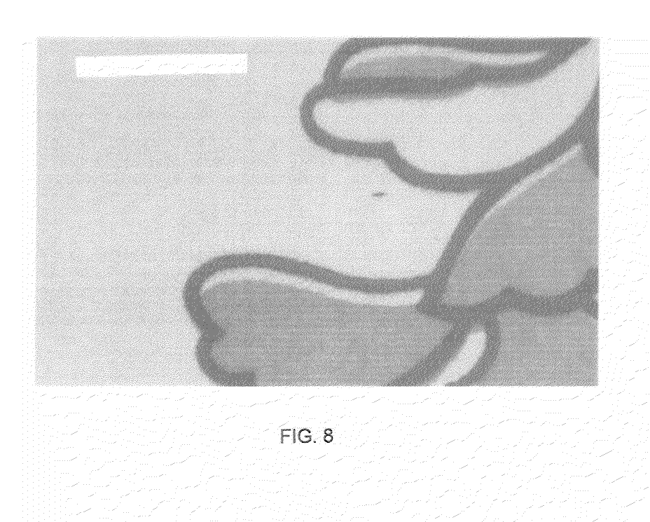

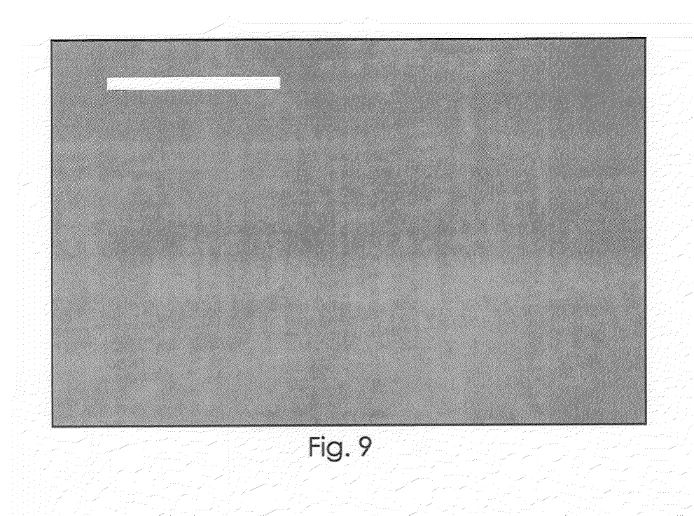

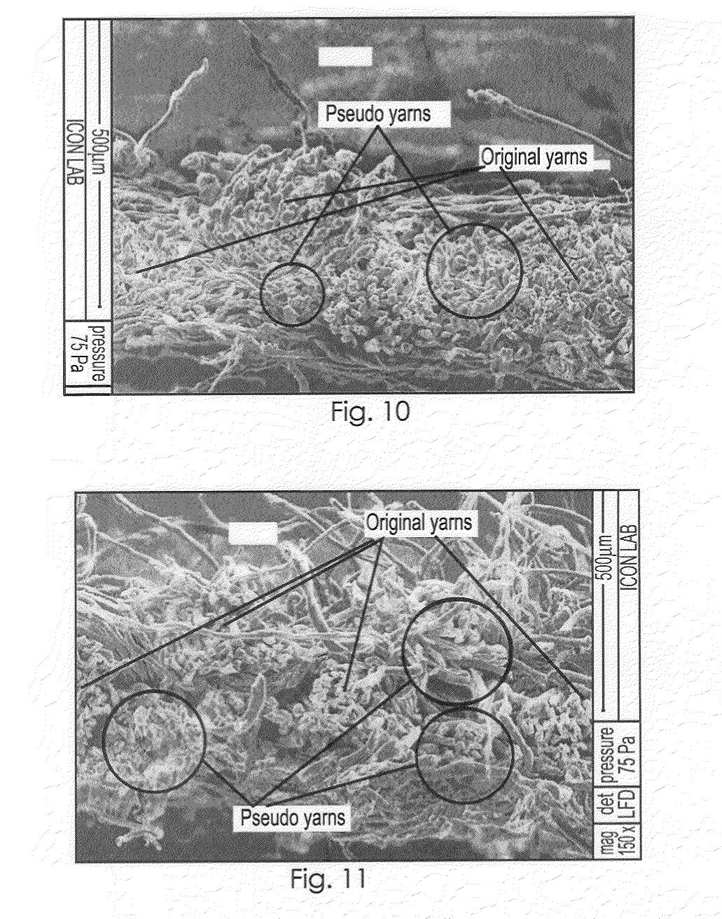

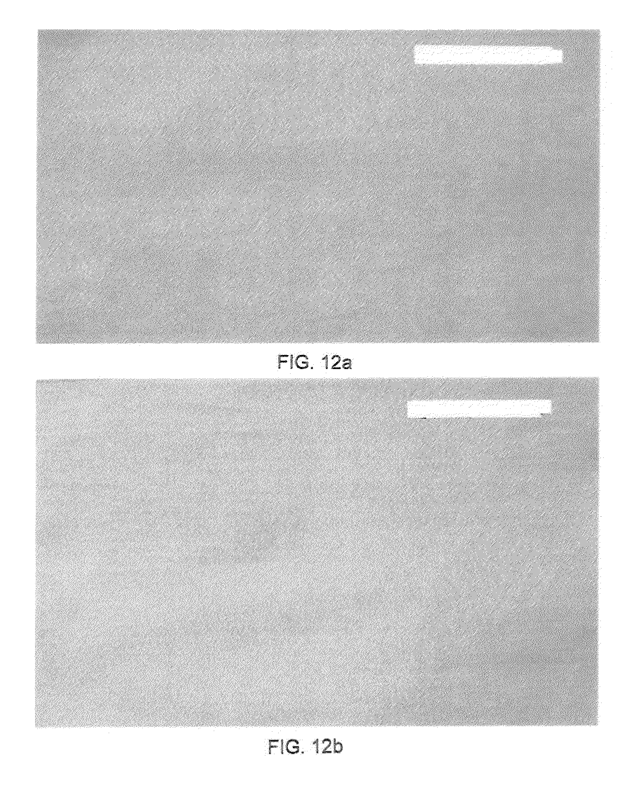

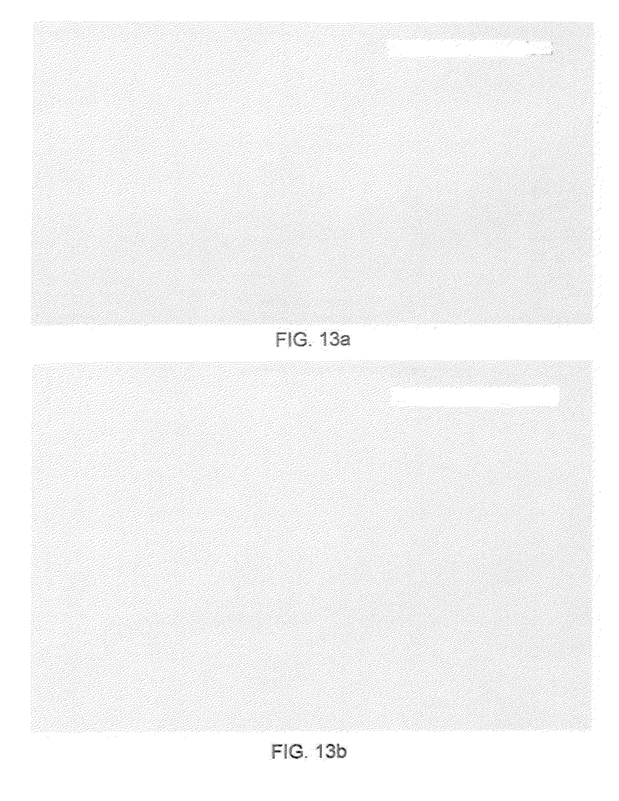

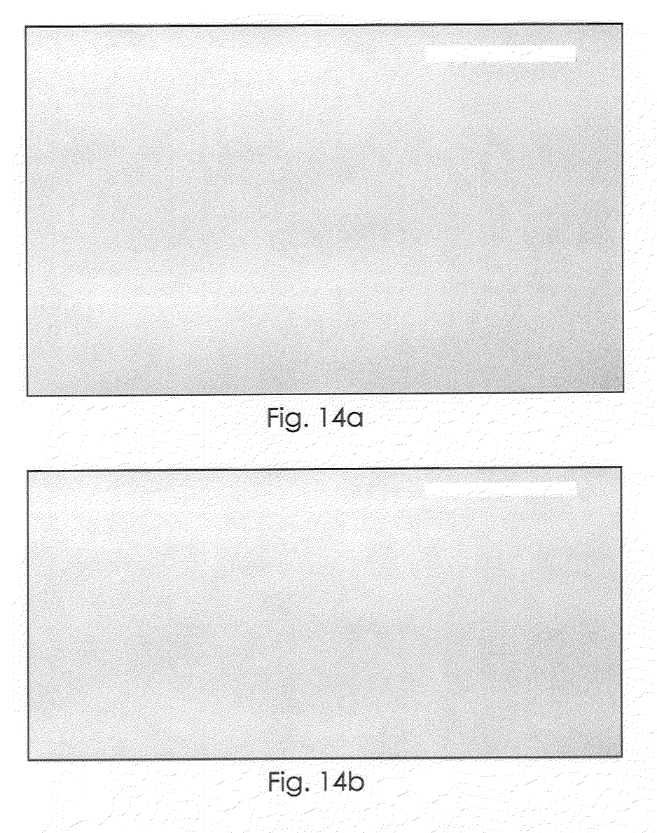

Material so formed, is further treated with chemicals for pre treatment, dyeing and/or printing and post treatment. The final product so delivered and as shown in FIG. 8, 9 and dyed/bleached fabric as shown in FIGS. 12(a) and (b), 13(a) and (b) and 14(a) and (b), now onwards will be called as wonder fabric.

Textile substrate is taken directly from weaving machine or knitting machine. Also, it is possible that textile substrate is dyed and processed before hand.

In an embodiment, the textile substrate is subjected to at least one high pressure straight jet stream. Further, the said textile substrate is also subjected to at least one jet stream that strikes at an angle. As required, direction of fabric movement is adjusted in such a way that jets and textile substrate move in the same direction or oppose each other. In either case, yarns from textile substrate are subjected to combing/stripping action and thereby resulting in to rearrangement of fibers in the yarns and making it suitable for serving as the support material during formation of pseudo yarns. This also results in to random fiber entanglements resulting in to yarn structure which can not be untwisted or disintegrated easily. This also results in to partial entanglement of fibers from component yarns. As per requirement, the entanglement level can be controlled thereby improving fabric properties.

By selecting proper jet stream parameters like jet size of 0.079 mm to 0.14 mm, with suitable energy when strikes textile substrate, suitable hand-feel and touch are created.

In a preferred embodiment, the invention provides a multipurpose wonder fabric suitable for home textile, upholstery and apparel textile application comprising at least one textile substrate with see-through and unstable construction, hydro-laminated with pseudo yarns so formed by hydro-entangling fibers on at least one side of textile substrate. The wonder fabric will have at least one textile substrate hydro-entangled with cross linking fibers at least on one side.

The said textile substrate is manufactured using weaving technology or knitting technology. Further, textile substrate can be manufactured from natural fibers or manmade fibers or their blends. The said textile substrate is constructed with yarn counts in the range of Ne 1 to 160, preferably in the range of Ne 5 to 160. Further, said textile substrate if woven, is constructed with 42 up to 300 threads/inch in warp way direction, preferably in the range of 30 to 168 threads/inch and 15 to 500 threads/inch in weft way direction, preferably in the range of 25 to 300 threads/inch and with a plain or twill or satin or combination weave and with weight of 45 up to 1200 g/m² preferably in the range of 45 to 300 and if warp knitted or weft knitted, with weight of 60 up to 400 g/m².

The fibers used for formation of said pseudo yarns are selected from natural or manmade fibers or blends thereof.

In another embodiment, the invention provides an assembly for manufacturing of wonder fabric comprising, an opening line which comprises a bale opener 302, a heavy trash separator 303, a multimixer 304, a fine opener 306 and card feeder 308 for cleaning and opening the fiber material for feeding to carding machine 314, a carding machine 314 for individualization and arranging of fibers in a required manner, a fabric unwinding expanding and tensioning device 310 and as a part of hydro-lamination device 324, a fabric combing device 319 comprising of at least one perforated drum 322a, 322b, 322c (there may be additional drums) or at least one perforated belt or at least one perforated drum with belt and with at least one straight jet stream and/or at least one jet stream striking textile substrate at an angle via injectors 320a, 320b, 320c, 320d, 320e, 320f, 320g, 320h, 320i. There may be additional injectors or fewer injectors as well. Perforated drums 322a, 322b, 322c if covered can be with perforated sleeve or perforated belt. Hydro-lamination assembly 324 further comprises at least one perforated drum or plurality of drums 322a, 322b, 322c comprising of at least one straight jet stream or plurality of jet streams with pressures gradient as required for hydro-lamination and at least one high pressure straight jet stream and at least one jet stream striking drum at an angle and at least one oscillating injector. These are shown as injectors 320a, 320b, 320c, 320d, 320e, 320f, 320g, 320h, 320i. Perforated drum or drums 322a, 322b, 322c are covered with belt with suitable openness or metal or plastic sleeve with suitable perforations, a dewatering device 326 for dewatering of wonder fabric, a dryer 328 for drying of wet wonder fabric, winder 332 for winding of dried wonder fabric, a padless chainless or chain merceriser for mercerization, swelling and preparation of wonder fabric for textile dyeing and finishing process, an open width continuous bleaching/dyeing range for dyeing of wonder fabric, a padder with curing device for padding of chemical agents followed by fixation, a soft flow machine or jet dyeing machine as required for pretreatment and dyeing of wonder fabric, an open width machine or soft flow machine for top finishing of wonder fabric, an emerising machine or raising machine for mechanical surface finishing of wonder fabric, a sanforisation machine or decatising machine for dimensional stabilization of wonder fabric, a knife coater or padder or kiss roll arrangement or zimmer machine followed by curing device for coating of wonder fabric on at least one side with chemicals like polyurethane, thermoplastc polyolephenes, thermoplastic polyurethane, polyurethane plus aluminium, etc. and a lamination device for lamination of wonder fabric on at least one side with membrane/films made out of PU or TPU or TPO, FR Material, etc., followed by cross linker.

In another embodiment, the invention provides a process for manufacturing pseudo yarns comprising following steps, as seen in FIG. 16:
a. pre-entangling fibers 1615 of web thereby creating necessary strength in the web;
b. supporting the web of step (a) on at least one side of textile substrate 1635;
c. subjecting web of step (b) to at least one jet stream at required pressure or plurality of jet streams 1640 with pressure gradient resulting into web disintegration and slipping away of fibers 1645 and;
d. rolling around of fibers formed in step (c) in the same space being supported by textile substrate thereby resulting in to formation of pseudo yarns 1650.

In yet another embodiment, also shown in FIG. 16, the invention provides for a process for manufacturing of wonder fabric comprising steps of:
a. opening and cleaning of fibers in opening machines 1605;
b. individualizing the fibers of step (a) in carding machine thereby delivering web of fibers 1610;
c. opening of textile substrate by expander roll 1620;
d. tensioning of textile substrate of step (c) through fabric tensioner 1625 and then subjecting it to high pressure water jets 1630 striking straight and/or at an angle;
e. layering of pre-treated textile substrate of step (d) with pre-entangled fiber web of step (b) for the formation of pseudo yarns 1655 as claimed in claim 8;
f. subjecting the pretreated textile substrate of step (d) and pseudo yarns of step (e) to at least 1 high pressure water jet 1660, striking straight or at an angle and oscillating water jet so as to form wonder fabric;
g. dewatering wonder fabric of step (f) by passing through dewatering device 1665;
h. drying dewatered wonder fabric of step (g) by passing through dryer wherein temperature is adjusted according to fiber type such that, dried fabric is left with residual moisture equal to natural moisture regain of the fiber 1670;
i. winding dried wonder fabric of step (h) on to bobbins/tubes by using winder 1675;
j. chemically pre-treating and/or drying and/or dyeing and/or printing and top finishing the wonder fabric of step (i) 1680 so that it can be used for textile applications like home, upholstery and apparel textile, and/or;
k. coating or laminating of wonder fabric of step (h) for technical textile and upholstery application 1685.

Textile substrate can be made out of natural or manmade fibers or their blends. It can be woven or knitted or composite material but with see through and unstable construction.

Staple fibers are opened or opened and cleaned followed by carding. One can use a classical non woven card with worker/stripper rolls or a flat card. After carding, these fibers are delivered in the web form. If required this fiber web is lightly entangled using water jets

So pre-entangled fibers or non-entangled fibers are delivered on top side of textile substrate. In case, fibers are non-entangled before; these fibers are lightly entangled now so that they are capable of taking higher level of energy from high pressure water jets.

While the invention has been explained with reference to the specific examples of the invention, the explanation is illustrative, and the invention is limited only by the appended claims (after explaining the invention)

### Example 1

0.1 mm jet with 23 jets/inch arranged in single row strikes the web at pressure of 50 bar there by creating fiber entanglement level resulting in to tensile breaking load of 4.5 Newton/meter of width of web in machine direction and 1.7 Newton/meter of width of web in cross direction.

This fiber web then is subjected to a plurality of water jets designed with parameters suitable for forming pseudo yarns on the surface of the textile substrate. In this case, textile substrate works as support for fiber web. Textile substrate guides and facilitates rolling around of fibers from web there by making these fibers to entangle among themselves and form pseudo yarns.

### Example 2

Textile substrate with fabric cover factor of 14 is layered with cotton fiber web and whole structure is subjected to high pressure water jet streams with jet description of 0.1 mm/23 jets/inch, 0.1 mm/40 jets/inch and 0.1 mm/40 jets/inch results into maximum fiber rolling and pseudo yarn formation as shown in FIG. 4, with very few traces of fibers on the bottom side of textile substrate.

Above phenomena is also influenced by fiber properties like polymer, fiber length, stiffness, diameter and surface friction. Web properties like fiber orientation, fiber individualization also influence the above phenomena.

Above structure is then subjected to at least one high pressure water jet stream. Fibers from pseudo yarns entangle with fibers of yarns from textile substrate. Water jet parameters are selected according to the balance between strength and product stiffness.

### Example 3

Textile substrate with 80 g/m2 and pseudo yarn structure with 35 g/m² when subjected to high pressure water stream with 0.1 mm jet size, arranged in single row results into pilling resistance of 5.0 and fabric stiffness acceptable for sheeting application.

Out of various attributes of textile fabric meant for home and apparel textile, first and foremost attribute important for any consumer is look of the fabric, and then comes feel. This is followed by the strength and durability. With time and increasing awareness of safety and hygiene, attributes like antimicrobial, odor kill, fire retardancy, etc., are becoming more and more important.

On the other hand, cost is also important aspect. Those products which deliver required look and attributes at nominal cost will have a surety of sale. This is known as value for money.

As described above in the background of invention, raw material cost is the biggest of all the components of cost. On account of technological limitations of spinning and weaving or knitting, technically and commercially important raw material properties like fiber length, strength, etc., can not be dropped below a particular limit. Therefore using this approach of value engineering by use of inferior raw material, costs can not be reduced drastically, for example; to the tune of 15 to 50%. Also, there is a risk of overall drop in operation efficiency. This for sure will deliver inferior product.

In this invention, a different and unique approach is followed. Textile substrate is designed and constructed with very open and see through construction there by reducing weight of the textile substrate to the tune of 15 to 50%. This brings down the cost drastically to the level of up to 50%. However, this textile substrate in it's as it is form is not stable and also is not having a look and other attributes acceptable for home, upholstery and apparel application.

This invention uses this textile substrate as a support for the entanglement and formation of pseudo yarns. The fibers from web once subjected to high pressure water jets, prefer to slide down into the gaps. These fibers prefer to entangle among themselves first till they achieve a certain packing density. This gives rise to formation of pseudo yarns. So formed pseudo yarns along with textile substrate, when subjected further to high pressure water jets, entangle through their fibers with the fibers from yarns of textile substrate.

The remaining fibers which do not roll down and become part of pseudo yarns entangle with the fibers from yarns of textile substrate. This way they cross-link among the yarns of textile substrate. This also depicts the fabric properties. By using the process defined in this invention, one can achieve durable press rating of at least 3.0 meaning wonder fabric so done is easy care, by default.

Phenomena described above also results in to introducing dimensional stability in the unstable textile substrate.

### Example 4

Textile substrate with Ne 40/1×Ne 40/1 and 100×68 threads/inch in warp and weft respectively and web of 26 mm cotton fibers, when operated through this invention results into residual shrinkage of less than 4.0% in warp and less than 2% in weft way direction. This is in contrast to the original shrinkage potential of 12% in warp and 6% in weft way direction as tested in textile substrate.

Apart from look, pseudo yarns so formed and entangled with yarns from textile substrate depict the tensile strength, tear strength. One can find the improvement in tensile strength by at least 25%. Tear strength also improves by at least 8%.

### Example 5

Textile substrate with Ne 40/1×Ne 40/1 and 107×38 threads/inch in warp and weft way direction when run along with cotton fiber web made out of 24 mm and 22 g/tex strength through findings of the invention gives breaking load 90 lb (+50%) and 34 (+20%) lb when tested for tensile strength. This also delivers tear strength of 4.5 lb (+35%) and 3.5 lb (+15%) in weft way direction.

Both pseudo yarn formation and entanglement with yarns from textile substrate along with cross-linking fibers entanglement with yarns from textile substrate result in to 15 to 35% improvement in resistance for seam slippage.

This invention not only blooms out yarns from textile substrate but also introduces high number of pores and continuous capillaries there by the wonder fabric delivered is highly absorbent and is capable of quick transportation of moisture through capillaries.

### Example 6

Textile substrate with Ne 20/1×Ne 20/1 and 45×25 threads/inch along with cotton fiber pseudo yarns when treated using findings of the invention, wonder fabric so delivered possesses the absorption rate of less than 1 second.

Vertical wicking test shows the attainment of 13 cm in 30 minutes. This implies that wonder fabric so done is highly comfortable to wear.

During hydro-lamination, wonder fabric is subjected to at least one oscillating high pressure jet stream there by inculcating look features.

Wonder fabric so formed is also subjected to at least one high pressure jet stream which strikes the hydro-laminated surface at an angle there by inculcating durability features.

The invention provides the line configuration for the manufacture of multi-purpose wonder fabric comprising of opening line for opening of fibers in bale or similar form into small fiber tufts, carding machine for individualization of fibers and form the web with suitable fiber orientation, transport arrangement for web up to hydro-lamination device, fabric unwinder for proper unwinding of fabric, expander and pre-tensioning roll for expanding and controlling fabric width and do not allow formation of creases, hydro-lamination device for formation of pseudo yarns, their entanglement with yarns of textile substrate, cross linking of fibers with yarns of textile substrate, combing through and stabilization of yarns from textile substrate, dewatering device for removing physically held water, dryer for removing chemically held water and winder for winding of so formed wonder fabric. For apparel, home textile and upholstery application, it is processed through traditional textile processing machines. For technical textile and upholstery application, it is processed through coating and/or lamination machines.

The invention provides following process for manufacturing of wonder fabric. The process comprises following steps:
a. Opening 1620, adjusting width and pre tensioning 1625 of textile substrate there by preventing formation of wrinkles or creases.
b. Cleaning and combing through yarns of textile substrate with high pressure water jet stream 1630 there by cleaning the surface, inculcating required shape and dimensions and entanglement among fibers and/or yarns as desired and to a level as desired so that textile substrate becomes suitable support for pseudo yarn formation.
c. Opening 1605 and carding 1610 of fibers and form the web 1615 with desired web properties.
d. Overlapping so formed web on the top of one of the sides of textile substrate 1635 and subject both to at least one or plurality of high pressure jet streams 1640, slipping off fibers 1645, and rolling the fibers 1650, thereby forming pseudo yarns, entangle them with yarns from textile substrate and also cross link the remaining fibers with the yarns from textile substrate 1655. thereby delivering wonder fabric with desired properties, and subjecting the pseudo yarns and textile substrate to high pressure water jets 1660.
e. So formed wonder fabric is dewatered 1665 using dewatering device followed by drying 1670 using dryer.
f. Dried wonder fabric is then wound 1675 on to bobbins or rolls by winder.
g. This wonder fabric is then processed through chemical processing like dyeing and surface finish 1680 for home, upholstery and apparel textile application.
h. This wonder fabric is processed through coating/lamination machines 1685 so as to manufacture upholstery and technical textile products like black-out curtains, barrier fabrics, shoe uppers, soft covers for automobiles, etc.

The invention is more specifically explained by following examples. However, it should be understood that the scope of the present invention is not limited by the examples in any manner. It will be appreciated by any person skilled in this art that the present invention includes following examples and further can be modified and altered within the technical scope of the present invention.

### Example 7

The following table shows how the invention inculcates high absorption rate in the so created wonder fabrics. Textile substrates with different counts and constructions along with cotton fiber pseudo yarns are processed using method as defined by this invention there by they exhibit the high absorption rate.

Water Absorption Test

Test Method used: AATCC 79

Test Conducted by: SGS, Mumbai

TABLE 1
Test Results:

| | | | | | | | Absorption |
|---|---|---|---|---|---|---|---|
| Sr. No. | ITS ID | Fabric ID | EPI | PPI | Wrp Ct | Weft Ct | Time (sec) |
| 1. | 13999 | 4031D | 107 | 38 | 40 cw | 40 cw | 1 |
| 2. | 14000 | 6031D | 96 | 45 | 60 cw | 60 cw | 1 |
| 3. | 14009 | 6031W | 96 | 45 | 60 cw | 60 cw | 1 |
| 4. | 14003 | 6031P | 96 | 45 | 60 cw | 60 cw | 1 |
| 5. | 14010 | 4032W | 107 | 38 | 40 cw | 40 cw | 1 |
| 6. | 14007 | 3031W | 49 | 34 | 30 cw | 30 cw | 1 |
| 7. | 14008 | 4031W | 107 | 38 | 40 cw | 40 cw | 1 |

### Example 8

The following table shows that different textile substrates along with pseudo yarns made out of cotton fibers when processed using findings of the invention result into having a high water wicking rate. This high wicking rate combined with high absorption rate provides a high level of comfort to the user.

Vertical Wicking Test

Test Method: SGS in house

Test Conducted by: SGS

TABLE 2
Test Results:

| Sr. No. | Fabric ID | EPI | PPI | Wrp Ct | Weft Ct | After 5 Min in Cms | After 30 Min in Cms |
|---|---|---|---|---|---|---|---|
| 1 | C212-1 | 45 | 25 | 20 kd | 20 kd | 8.1 | 13.3 |
| 2 | C252 | 68 | 45 | 40 kd | 40 kd | 7.7 | 13 |
| 3 | C222 | 56 | 25 | 20 kd | 20 kd | 7.2 | 12.6 |
| 4 | C212-2 | 45 | 25 | 20 kd | 20 kd | 7.3 | 12.8 |
| 5 | C232 | 45 | 25 | 30 kd | 30 kd | 7.6 | 13.3 |
| 6 | C241 | 56 | 25 | 30 kd | 30 kd | 7.5 | 12.5 |

### Example 9

One can see from the table that this invention delivers wonder fabric which is highly durable.

Different textile substrates as shown in the table along with pseudo yarns made out of polyester/cotton fiber blend are processed using findings of invention result in to a very good resistance for pilling. The test is conducted on the hydro-laminated side so as to establish the high durability.

Pilling Test

Test Method used: ASTM 4970

Test Conducted by: ITS, Mumbai

TABLE 3
Test Results:

| | | | | | | | Pilling After 100 Cycle | |
|---|---|---|---|---|---|---|---|---|
| Sr. No. | | Fabric ID | EPI | PPI | Wrp Ct | Weft Ct | ITS | Protocol |
| 1 | 13999 | 4031D | 107 | 38 | 40 cw | 40 cw | 5 | 3 |
| 2 | 14000 | 6031D | 96 | 45 | 60 cw | 60 cw | 5 | 3 |
| 3 | 14001 | 4031P | 107 | 38 | 40 cw | 40 cw | 5 | 3 |
| 4 | 14003 | 6031P | 96 | 45 | 60 cw | 60 cw | 5 | 3 |
| 5 | 14004 | 3031P | 49 | 34 | 30 cw | 30 cw | 5 | 3 |
| 6 | 14007 | 3031W | 49 | 34 | 30 cw | 30 cw | 5 | 3 |
| 7 | 14008 | 4031W | 107 | 38 | 40 cw | 40 cw | 5 | 3 |
| 8 | 14009 | 6031W | 96 | 45 | 60 cw | 60 cw | 5 | 3 |
| 9 | 14010 | 4032W | 107 | 38 | 40 cw | 40 cw | 5 | 3 |

### Example 10

From the following table, one can depict that wonder fabric manufactured using findings of invention exhibits a very good dimensional stability. It is interesting to note that fabric is stabilized using fiber rearrangement in the yarns of textile substrate followed by further higher level of entanglement among fibers in these yarns. The traditional process of crimp interchange and rearrangement in thread density for fabric stabilization is not used here in this invention. Cross-linking fibers also entangle with fibers from yarns of textile substrate and there by help stabilize the structure of wonder fabric. The level of entanglement is controlled to a level there by attaining acceptable stiffness and feel of wonder fabric so manufactured.

Dimensional Stability Test

Test Method used: AATCC 135-2003

Test Conducted by: WIL, Anjar

TABLE 4
Test Results:

| | | | | | | | | Residual | | Residual | |
|---|---|---|---|---|---|---|---|---|---|---|---|
| | | | | | | | | Shrinkage | | Shrinkage | |
| | | | | | | | | % Warp 5 wash | | % Weft 5 wash | |
| | | | | | | | | WIL- | | WIL- | |
| Sr. No. | ITS ID | Fabric ID | EPI | PPI | Wp Ct | Wft Ct | | Anjar | Protocol | Anjar | Protocol |
| 1. | 14009 | 6031W | 96 | 45 | 60 cw | 60 | Cw | 3 | 3 | 0.5 | 3 |
| 2. | 14010 | 4032W | 107 | 38 | 40 cw | 40 | Cw | 2.5 | 3 | 1 | 3 |
| 3. | Grey | 6030W | 102 | 50 | 60 cw | 60 | cw | −10 | | 5.6 | |
| 4. | Grey | 4030W | 110 | 40 | 40 cw | 40 | cw | −9 | | 4.5 | |

### Example 11

Following table shows that different textile substrates along with cotton pseudo yarns with 25 to 40 g/m² are manufactured using findings of invention result in to DP rating of at least 2.5 which is well above protocol requirement for sheeting fabric.

Amount of entanglements between cross-linking fibers and yarns of textile substrate and the orientation of the same depict this wrinkle behavior.

Durable Press Rating

Test Method used: AATCC 124-2001

Test Conducted by: ITS

TABLE 5
Test Results:

| | | | | | | | DP Rating 5 Wash | |
|---|---|---|---|---|---|---|---|---|
| Sr. No. | | Fabric ID | EPI | PPI | Wrp Ct | Weft Ct | ITS | Protocol |
| 1 | 13999 | 4031D | 107 | 38 | 40 cw | 40 cw | 3 | 2.2 |
| 2 | 14000 | 6031D | 96 | 45 | 60 cw | 60 cw | 2.75 | 2.2 |
| 3 | 14001 | 4031P | 107 | 38 | 40 cw | 40 cw | 3.25 | 2.2 |
| 4 | 14003 | 6031P | 96 | 45 | 60 cw | 60 cw | 3.25 | 2.2 |
| 5 | 14004 | 3031P | 49 | 34 | 30 cw | 30 cw | 3 | 2.2 |
| 6 | 14007 | 3031W | 49 | 34 | 30 cw | 30 cw | 2.5 | 2.2 |
| 7 | 14008 | 4031W | 107 | 38 | 40 cw | 40 cw | 3 | 2.2 |
| 8 | 14009 | 6031W | 96 | 45 | 60 cw | 60 cw | 3 | 2.2 |
| 9 | 14010 | 4032W | 107 | 38 | 40 cw | 40 cw | 2.75 | 2.2 |

### Example 12

Depending upon amount of entanglement between pseudo yarns and yarns from substrate, level of entanglement among fibers in the yarns of textile substrate, orientation and amount of entanglement between cross-linking fibers and yarns from textile substrate depict the resistance for seam slippage.

Following table shows that different textile substrates with cotton fiber web when subjected to the process as depicted by this invention result in to high resistance to seam slippage.

It is important to remember the fact that textile substrate in it's original form is with very open construction and also is unstable. In this form, textile substrate is not at all suitable for applications in home and apparel textile.

Seam Slippage

Test Method used: ASTM D 434 1995; ASTM D 5034 FIXED SEAM OPENING

Test Conducted by: ITS

TABLE 6
Test Results:

| | | | | | | | SEAM SLIPPAGE | | | |
|---|---|---|---|---|---|---|---|---|---|---|
| | | | | | | | WARP | Warp | WEFT | Weft |
| Sr. No. | | Fabric ID | EPI | PPI | Wrp Ct | Weft Ct | WIL-Anjar | Protocol | WIL-Anjar | Protocol |
| 1 | 13999 | 4031D | 107 | 38 | 40 cw | 40 cw | 16 | 15.00 | 39.00 | 15.00 |
| 2 | 14000 | 6031D | 96 | 45 | 60 cw | 60 cw | 16 | 15.00 | 39.00 | 15.00 |
| 3 | 14001 | 4031P | 107 | 38 | 40 cw | 40 cw | 22 | 15.00 | 43.00 | 15.00 |
| 4 | 14003 | 6031P | 96 | 45 | 60 cw | 60 cw | 23 | 15.00 | 42.00 | 15.00 |
| 5 | 14004 | 3031P | 49 | 34 | 30 cw | 30 cw | 32 | 15.00 | 39.00 | 15.00 |
| 6 | 14007 | 3031W | 49 | 34 | 30 cw | 30 cw | 26 | 15.00 | 44 | 15.00 |
| 7 | 14008 | 4031W | 107 | 38 | 40 cw | 40 cw | 21 | 15.00 | 34.0 | 15.00 |
| 8 | 14009 | 6031W | 96 | 45 | 60 cw | 60 cw | 20 | 15.00 | 35.0 | 15.00 |
| 9 | 14010 | 4032W | 107 | 38 | 40 cw | 40 cw | 25 | 15.00 | 44.0 | 15.00 |

### Example 13

The following table shows that wonder fabric comprising of different textile substrates with open and unstable construction along with cotton fiber web with more fibers oriented in warp way direction when treated through the process depicted by invention results in to acceptable tensile strength in both warp and weft direction.

Since more fibers are oriented in warp way direction result in to higher tensile strength in that direction.

Tensile Testing Test

Test Method: ASTM D 5034

Test Conducted by: ITS

TABLE 7
Test Results:

| | | | | | | | Warp Force | | Weft Force | |
|---|---|---|---|---|---|---|---|---|---|---|
| | | | | | | | in Lbs | | In lbs | |
| Sr. No. | | Fabric ID | EPI | PPI | Wrp Ct | Weft Ct | ITS | Protocol | ITS | Protocol |
| 1. | 14007 | 3031W | 49 | 34 | 30 cw | 30 cw | 79.2 | 30 | 31.89 | 30 |
| 2. | 14008 | 4031W | 107 | 38 | 40 cw | 40 cw | 71.3 | 30 | 34.92 | 30 |
| 3. | 14009 | 6031W | 96 | 45 | 60 cw | 60 cw | 63.5 | 30 | 35.65 | 30 |
| 4. | 14010 | 4032W | 107 | 38 | 40 cw | 40 cw | 113.8 | 30 | 32.08 | 30 |

### Example 14

Following table shows that wonder fabric so manufactured delivers required tear strength.

Tear Strength Test

Test Method: ASTM D 1424-2007A (Elmendorf Tester)

Test Conducted by: ITS

TABLE 8
Test Results:

| | | | | | | | Warp | | Weft | |
|---|---|---|---|---|---|---|---|---|---|---|
| Sr. No. | | Fabric ID | EPI | PPI | Wrp Ct | Weft Ct | ITS | Protocol | ITS | Protocol |
| 1. | 14007 | 3031W | 49 | 34 | 30 cw | 30 cw | 3.9 | 1.5 | 1.6 | 1.5 |
| 2. | 14008 | 4031W | 107 | 38 | 40 cw | 40 cw | 2.7 | 1.5 | 1.8 | 1.5 |
| 3. | 14009 | 6031W | 96 | 45 | 60 cw | 60 cw | 2.6 | 1.5 | 1.9 | 1.5 |
| 4. | 14010 | 4032W | 107 | 38 | 40 cw | 40 cw | 3.8 | 1.5 | 1.5 | 1.5 |

The foregoing descriptions of the invention are intended to be illustrative and not limiting. Those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Although the present invention has been described with reference to specific exemplary embodiments, one of ordinary skill in the art would know that various modifications and changes may be made to these embodiments without departing from the broader spirit and scope of the invention. Accordingly, the specification and drawings are illustrative, rather than restrictive. All patents, patent applications and publications cited herein are fully incorporated by reference in their entirety.

1. A multipurpose wonder fabric for home textile, upholstery and apparel textile application comprising at least one textile substrate with see through and unstable construction hydro-laminated with pseudo yarns so formed by hydro-entanglement of fibers on at least one side of the textile substrate.

2. The multipurpose wonder fabric as claimed in claim 1, comprising at least one textile substrate hydro-entangled with cross-linking fibers at least on one side.

3. The multipurpose wonder fabric as claimed in claim 1, wherein said textile substrate is manufactured using weaving technology.

4. The multipurpose wonder fabric as claimed in claim 1, wherein said textile substrate is manufactured using knitting technology.

5. The multipurpose wonder fabric as claimed in claim 1, wherein said textile substrate is made of natural or manmade fibers or their blends.

6. The multipurpose wonder fabric as claimed in claim 1, wherein the fibers used for formation of pseudo yarns are natural fibers or manmade fibers or their blends.

7. The multipurpose wonder fabric as claimed in claim 1, wherein the said wonder fabric is manufactured using an assembly comprising:
a. an opening line;
b. a carding machine;
c. a fabric unwinding, expanding and tensioning device and as a part of hydro-lamination, a fabric combing device comprising at least one perforated drum with at least one high pressure straight jet stream and/or a jet stream striking textile substrate at an angle, wherein said perforated drum, is either covered with a sleeve or a belt with suitable openness or is not covered;
d. a hydro-lamination unit with at least one perforated drum or plurality of perforated drums, comprising of at least one high pressure straight jet streams or plurality of them with pressure gradient and also comprising of at least one jet stream striking at angle and/or oscillating wherein, the perforated drum/drums, are either covered with a belt or a sleeve with suitable openness and arrangement or are not covered;
e. a dewatering device for dewatering of wonder fabric;
f. a dryer for drying of wet wonder fabric;
g. a winder for winding of dried wonder fabric;
h. a padless chainless or chain mercerizer for mercerization, swelling and preparation of wonder fabric for textile dyeing and finishing process, which is applicable for cotton fiber based wonder fabric;
i. an open width continuous bleaching/dyeing range for dyeing of wonder fabric;
j. a padder with curing device for padding of chemical agents followed by fixation which is applicable for manmade fibers and blends;
k. a soft flow machine or jet dyeing machine for pretreatment and dyeing of the wonder fabric;
l. an open width machine or soft flow machine for top finishing of the wonder fabric;
m. an emerizing machine or raising machine for mechanical surface finishing of wonder fabric;
n. a sanforization machine for dimensional stabilization of wonder fabric;
o. a knife coater, or padder, or kiss roll arrangement, or zimmer machine, followed by a curing device for coating of wonder fabric on at least one side with chemicals selected from the group consisting of thermoplastic polyolephenes, thermoplastic polyurethane, and polyurethane/aluminum; or
p. a lamination device for lamination of wonder fabric on at least one side with membrane/films made out of polyurethane, thermoplastic polyurethane, thermoplastic polyolephene, or a flame retardant material, followed by a cross-linker.

8. The multipurpose wonder fabric as claimed in claim 1, wherein the process for manufacturing said pseudo yarns comprises:
a. pre-entanglement of fibers of a web thereby creating necessary strength in the web; and
b. supporting the web on at least one side of the textile substrate followed by subjecting the web to at least one jet stream at a required pressure or a plurality of jet streams with a pressure gradient resulting into web disintegration and slipping away of fibers, followed by a rolling around of fibers in the same space being guided by textile substrate thereby resulting in the formation of pseudo yarns.

9. The multipurpose wonder fabric as claimed in claim 1, wherein the process for manufacturing said wonder fabric comprises:
a. fiber opening and cleaning in fiber opening machines followed by fiber individualization in carding machine there by delivering web of fibers;
b. opening up the textile substrate as claimed in claim 1 is opened up through expander roll followed by tensioning of textile substrate through a fabric tensioner followed by subjecting the textile substrate to high pressure water jets striking at an angle to form a pre-treated textile substrate;
c. layering the pre-treated textile substrate with the pre-entangled fiber web pseudo yarns;
d. subjecting the pre-treated textile substrate and pseudo yarns to a stationary or oscillating high pressure water jet striking straight and/or at an angle;
e. dewatering the wonder fabric by passing through a dewatering device;
f. drying the dewatered wonder fabric by passing through a dryer at a temperature which is adjusted according to fiber so the dried fabric is left with residual moisture content equal to natural moisture content of the fiber;
g. winding the wonder fabric on to bobbins/tubes by using winder; and
h. chemically pre-treating, dyeing, printing, and/or top finishing the wonder fabric for use in home, upholstery or apparel textile applications like home, upholstery and apparel textile; or
i. coating or laminating the wonder fabric for use in technical textile and upholstery applications.

10. The multipurpose wonder fabric as claimed in claim 1, wherein said textile substrate is constructed with yarn counts in the range of Ne 1 up to Ne 160 and wherein the yarns are either single yarns or plied yarns.

11. The multipurpose wonder fabric as claimed in claim 3, wherein said textile substrate is constructed with 30 up to 300 threads/inch in warp way direction and 12 up to 500 threads/inch in weft way direction and with a plain or twill or satin or combination weave and with weight of 45 up to 1200 g/m².

12. The multipurpose wonder fabric as claimed in claim 4, wherein said textile substrate 4 is constructed with 60 up to 400 g/m² and with warp or weft knitted structure.
